(19) United States
(12) Patent Application Publication
(10) Pub. No.: US 2025/0083618 A1
(43) Pub. Date: Mar. 13, 2025

(54) PANEL STRUCTURE FOR NOISE, VIBRATION AND HARSHNESS REDUCTION INSIDE A FRONT COMPARTMENT OF A VEHICLE

(71) Applicant: Volvo Car Corporation, Göteborg (SE)

(72) Inventors: Erik LEXBERG, Göteborg (SE); Zef VAN DER PUTTEN, Göteborg (SE); Thomas ENGLUND, Göteborg (SE); Michelle KHOO, Göteborg (SE); Niclas BENTZEN, Göteborg (SE); Gabriel NICOLESCU, Göteborg (SE)

(73) Assignee: Volvo Car Corporation, Göteborg (SE)

(21) Appl. No.: 18/822,840

(22) Filed: Sep. 3, 2024

(30) Foreign Application Priority Data
Sep. 8, 2023 (EP) 23196261.4

(51) Int. Cl. B60R 13/08; B60H 1/00; B60R 13/06; B62D 25/08

(52) U.S. Cl. CPC B60R 13/0838; B60H 1/00535; B60R 13/06; B62D 25/084

(57) ABSTRACT

In an aspect, the present disclosure relates to a structure comprising: a first attachment component configured for attaching the structure to a front compartment structure of a compartment of a vehicle such that the compartment is separated into a first compartment and a second compartment; a second attachment component configured for attaching a climate control system to the structure such that the climate control system is located in the first compartment when the structure is attached to the front compartment structure; and a sealing component configured for sealing off the first compartment of the compartment in an air-flow restricting manner against the second compartment when the structure is attached to the front compartment structure; and wherein the structure is for noise, vibration, and harshness reduction inside the compartment.

### CROSS-REFERENCE TO RELATED APPLICATIONS

This application claims the benefit of European Patent Application Number 23196261.4, filed on Sep. 8, 2023, which is hereby incorporated by reference in its entirety.

### TECHNICAL FIELD

The present disclosure relates to a panel structure for noise, vibration, and harshness (NVH) reduction inside a front compartment of a vehicle, a climate control structure, a front compartment of a vehicle, a vehicle, and a method for manufacturing a front compartment of a vehicle.

### BACKGROUND

In vehicles, even in electric vehicles, the design of the front compartment is complex given the different systems and their components that are provided inside the front compartment, such as the climate control system, and the individual requirements of such systems as well as preferences for the design of the vehicle. One exemplary preference is that it is desirable to deliver clean air from a compartment of the climate control system inside the front compartment to the cabin compartment inside the vehicle. Further, for example, it is desirable to have low NVH (noise, vibration and harshness) inside the cabin compartment, which may be the result of the operation of different systems, such as the climate control system, but also a drive system including an internal combustion engine or electric motor, or from the environment, for example.

### SUMMARY

It is an object of the invention to provide a cost-efficient and simple front compartment design of a vehicle, which fulfills several design preferences of the vehicle, in particular at least the ones mentioned above.

The object is at least partially solved by the subject matter of the independent claims of the present disclosure, wherein further examples are incorporated in the dependent claims.

According to a first aspect, there is provided a panel structure configured for noise, vibration and harshness reduction inside a front compartment of a vehicle, the panel structure comprising: first attachment component configured for attaching the panel structure to a front compartment structure of the front compartment of the vehicle such that the front compartment is separated into a first compartment and a second compartment; second attachment component configured for attaching a climate control system to the panel structure such that the climate control system is being located in the first compartment when the panel structure is attached to the front compartment structure; and sealing component configured for sealing off the first compartment of the front compartment in an air-flow restricting manner against the second compartment when the panel structure is attached to the front compartment structure.

The panel structure of the first aspect of this disclosure may provide for a design of a front compartment of a vehicle, when it is being inserted therein, which fulfills several preferences that improve the user experience with the vehicle and the assembly thereof, as explained in more detail below.

One of these preferences may be a low NVH (noise, vibration, harshness) level inside the cabin compartment of the vehicle, which may be provided by the panel structure. The panel structure may be substantially stiff, for example, which further increases the NVH decreasing capabilities of the vehicle. Substantially stiff may mean that the panel structure can resist deformation caused by dynamic forces acting thereupon, in particular until a level defined by its design and/or material. The panel structure may stiffen the entire front compartment structure, thereby reducing NVH transferred from the front compartment, e.g., from the road, an electric motor, and/or the climate control system, to the cabin compartment.

Another one of these preferences may be to have a safe, simple, and quick assembly of the climate control system inside the front compartment. In this regard, the panel structure comprises second attachment component configured for attaching the climate control system thereto. Thereby, the panel structure together with the climate control system may be pre-assembled as a climate control structure before the climate control structure is inserted into the front compartment and attached to the front compartment structure via the first attachment component. Such preassembly outside of the narrow front compartment may be made much casier, more ergonomically and faster.

Yet another one of these preferences may be to supply clean air from the climate control system inside the front compartment to the cabin compartment, in which the passengers of the vehicle are located. To achieve this, the panel structure has scaling component, which may scal off the first compartment, which may also be referred to as an air climate control system compartment, at least partially in an air-flow restricting manner, in particular substantially air-tight manner, against the second compartment of the front compartment, which may correspond to the front compartment without the first compartment. At least partially air-flow restricting in this regard means in particular that the scaling is provided at least along the panel structure. In other words, the air-flow restricting sealing is provided at least between the panel structure and the front compartment structure, to which it is being attached. Air-flow restricting means that the air is being restricted from flowing through the sealing, however, there may be minor air-leakage which can possibly not be prevented, i.e., when the sealing is damaged. The sealing, however, may be substantially air-tight, which means as air-tight as possible. Preferably, but not necessary, is the first compartment altogether, i.e., from sides other than the panel structure, substantially sealed in an air-flow restricting manner, in particular substantially air-tight, so as to prevent possibly polluted air from entering the first compartment. The air-tight sealing excludes specific air ducts of the climate control system provided for air intake and outtake. Thereby, the climate control system may for the most part or only use air via one or more air ducts as intakes for the climate control system rather than using air from inside the second compartment of the front compartment, which may be polluted or not desired as air for the cabin compartment. In particular, the scaling component may be configured for scaling off the climate control system compartment in an air-flow restricting manner, in particular substantially air-tight, against the second compartment of the front compartment. In this case, the air for the climate control system may be coming from the one or more air ducts of the climate control system only.

The panel structure may in particular be configured as a shear plane structure. As such, the shear plane structure is specifically designed to withstand shear forces acting thereon.

In an example, the panel structure may comprise a panel section and at least one beam section extending along a side of the panel section. The at least one beam section may be shaped as a beam. Such a beam may be a cross-sectional polygonal shape, e.g., rectangular, or otherwise rigid shaped. The beam may be hollow and/or a lengthy structure. The at least one beam section stiffens the panel structure and thereby the entire front compartment or front compartment structure, further effectively reducing NVH. Accordingly, this may provide for further reduction of NVH and more secure attachment of the climate control system and the front compartment structure to the panel structure. The side of the panel section, along which the at least one beam section extends, may be a long side of the panel section.

In an example, the panel section may be thinner than the at least one beam section. This means that a thickness of the panel section is less than a thickness of the at least one beam section. In particular, the panel section may be thinner than the at least one beam section in a direction of extension of the panel section that is perpendicular to the direction of extension of the at least one beam section along the side of the panel section. In particular, the panel section may be substantially planar. This provides for a light yet stiff panel structure.

In an example, the panel structure may comprise two beam sections. This further stiffens the panel structure for increased NVH reduction. Also, the attachment component may be arranged on two beam sections, which makes the attachment to the front compartment structure and the climate control system more secure.

In an example, the two beam sections may be extending along opposite sides of the panel section. The opposite sides may be long sides of the panel structure. In particular, the two beam sections may be extending substantially in parallel to one another. It has been found that this provides for a particularly stiff and easy to attach design of the panel structure.

In an example, the first attachment component may be arranged on the panel section and at least one of the at least one beam section. Thereby, both types of sections may serve for improved attachment to the front compartment structure.

In an example, the second attachment component may be arranged on the panel section and at least one of the at least one beam section. Thereby, both types of sections may serve for improved attachment to the climate control system.

In an example, the scaling component may be arranged at least at opposite sides of the panel section. In particular, the opposite sides may be short sides of the panel section, contrary to the long sides of the panel section, along which the at least one beam section may be extending. Further, the sealing component may be arranged on a substantially flat surface of the panel section at the opposite short sides of the panel section.

In an example, the scaling component may be configured as at least one scaling strip. In particular, several scaling strips may be used to achieve the desired air-tight sealing. The sealing strips may be made from an elastomer or a similar material, and attached to the panel structure by an adhesive, for example.

In an example, the panel structure may comprise at least one depressed portion. The at least one depressed portion may be depressed relative to a thereto adjacent portion of the panel structure. The at least one depressed portion may have a face configured for arrangement at, in particular surface contact with, a counter face of the front compartment structure. In particular, the panel structure may comprise two or more depressed portions. Thereby, the sealing of the first compartment by the panel structure and the attachment of the panel structure to the front compartment structure are further facilitated. The at least one depressed portion may be arranged at the panel section. It may be arranged between the two beam sections. In particular, two depressed portions may be arranged opposite of one another, in particular at the short sides of the panel structure, thereby conforming in shape to side structures of the front compartment structure.

In an example, the panel structure may be designed as an extrusion part. An extrusion part may be acquired by the process of extrusion. For the extrusion, the material from which the panel structure is to be manufactured may be pushed through a die having the desired cross-section of the extrusion part. This makes the panel structure particularly cost-effective. The depressed portions may consequently be provided by depressing portions of the panel structure.

In an example, the panel structure may be made from aluminum. Aluminum was found to make the panel structure sufficiently stiff yet light weight for the application in vehicles. It may be casily and cost-effectively processed by extrusion.

According to a second aspect of this disclosure, there is provided a climate control structure, the climate control structure comprising the panel structure of the first aspect of this disclosure and a climate control system, the climate control system being attached to the panel structure.

According to a third aspect of this disclosure, there is provided a front compartment of a vehicle, the front compartment comprising a front compartment structure and the climate control structure of the second aspect of this disclosure, the panel structure being attached to the front compartment structure, and the scaling component sealing off the first compartment of the front compartment in an air-flow restricting manner against the second compartment.

According to a fourth aspect of this disclosure, there is provided a vehicle comprising the front compartment of the third aspect of this disclosure.

According to a fifth aspect, there is provided a method for partially assembling a front compartment of a vehicle according to the third or fourth aspect of this disclosure, the method comprising:
assembling the climate control structure by attaching the climate control system to the panel structure,
inserting the assembled climate control structure into the front compartment, and
attaching the assembled climate control structure to the front compartment structure.

In an aspect, the present disclosure relates to a structure comprising: a first attachment component configured for attaching the structure to a front compartment structure of a compartment of a vehicle such that the compartment is separated into a first compartment and a second compartment; a second attachment component configured for attaching a climate control system to the structure such that the climate control system is located in the first compartment when the structure is attached to the front compartment structure; and a scaling component configured for sealing off the first compartment of the compartment in an air-flow restricting manner against the second compartment when the structure is attached to the front compartment structure; and wherein the structure is for noise, vibration, and harshness reduction inside the compartment.

In another aspect, the present disclosure relates to a compartment comprising: a structure; and a scaling component; wherein the structure is attached to the compartment such that the compartment is separated into a first compartment and a second compartment; wherein a climate control system is attached to the structure such that the climate control system is located in the first compartment when the structure is attached to the compartment; and wherein the scaling component seals off the first compartment of the compartment in an air-flow restricting manner against the second compartment.

In another aspect, the present disclosure relates to a method comprising: assembling a climate control structure by attaching a climate control system to a structure, wherein the climate control structure comprises the climate control system; inserting the assembled climate control structure into a compartment; and attaching the assembled climate control structure to a compartment structure of a vehicle, wherein the structure separates the compartment structure into a first compartment and a second compartment, and wherein the climate control system is located in the first compartment; and sealing, the first compartment of the compartment in an air-flow restricting manner against the second compartment.

In an aspect, a one of the first attachment component comprises at least one of a through-hole, a threaded hole, a bushing, a screw, and a bolt, and the second attachment component comprises one of a through-hole, a threaded hole, a bushing, a screw, and a bolt.

It should be noted that the above examples may be combined with each other irrespective of the aspects involved. Accordingly, the method may be combined with structural features and, likewise, the panel structure, climate control structure, front compartment and vehicle may be combined with features described above with regard to the method.

These and other aspects of the present disclosure will become apparent from and elucidated with reference to the examples described hereinafter.

### BRIEF DESCRIPTION OF DRAWINGS

Examples of the disclosure will be described in the following with reference to the following drawings.

FIG. 1 shows a perspective view on a front face of a panel structure according to this disclosure.

FIG. 2 shows a cross-sectional view on the panel structure of FIG. 1.

FIG. 3 shows a perspective view of a back face of the panel structure from FIGS. 1 and 2.

FIG. 4 shows a schematic illustration of a part of a vehicle comprising a front compartment, in which the panel structure of FIGS. 1 to 3 is installed.

FIG. 5 shows a schematic illustration of steps of a method for partially assembling a front compartment of a vehicle.

### DETAILED DESCRIPTION

The Figs are merely schematic representations and serve only to illustrate examples of the disclosure. Identical or equivalent elements are in principle provided with the same reference signs.

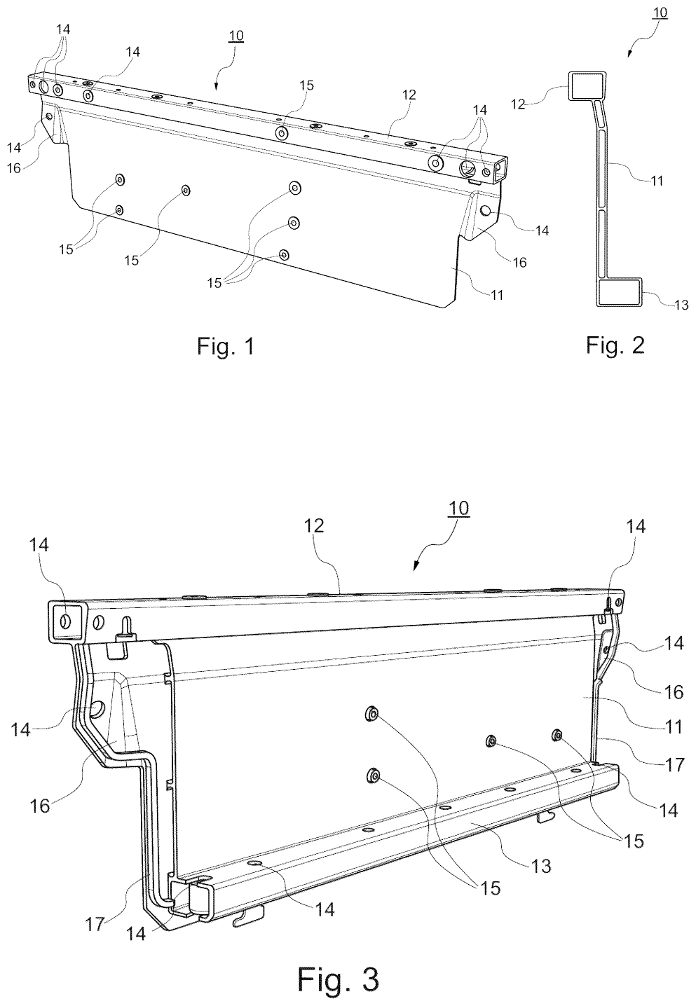

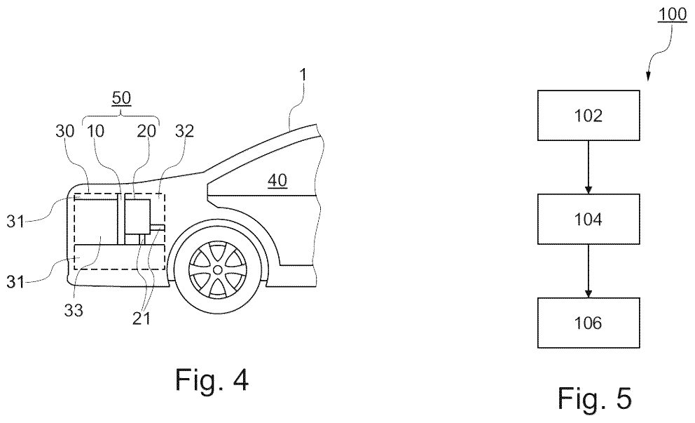

FIGS. 1 to 3 show different views on the same panel structure 10 for a front compartment 30 of a vehicle 1 (see FIG. 4).

FIG. 4 shows the assembly of the front compartment 30 of vehicle 1 as schematic illustration.

In the front compartment 30, several systems or at least some of their components may be housed. In an electric vehicle, for example, the electric motor (not shown) may be included in the front compartment 30. Another system inside the front compartment 30 is the climate control system 20. The climate control system 20 may comprise or be an air conditioning system of vehicle 1. Accordingly, the climate control system 20 may comprise components such as a compressor, condenser, valve, filter and/or airduct, for example. Several other systems may also be located inside the front compartment 30.

The front compartment 30 may transport noise, vibration, and harshness (NVH) to the adjacent thereto located cabin compartment 40, which may come from the systems or components inside the front compartment 30 as well as the environment, e.g., from the road. To reduce the NVH in the cabin compartment 40, the panel structure 10 may have a substantially stiff design, stiffening a front compartment structure 31, to which it is attached as will be explained further below.

In particular, the panel structure 10 comprises three sections, namely a panel section 11, a first beam section 12 and a second beam section 13. The panel section 11 may be substantially flat or, in other words, planar. The panel section 11 comprises opposite planar faces, one of these being shown in FIG. 2 and the opposite one being shown in FIG. 3. Further, the panel section 11 comprises sides located at the sides of these planar faces. The beam sections 12, 13 may be located at such opposite long sides of the panel section 11 and extending in length along the opposite long sides. The beam sections 12, 13 may be rectangular or otherwise shaped beams, stiffening the overall panel structure 10.

The panel structure 10 may be made from one piece or, in other words, designed integrally. For example, the panel structure 10 may be an extruded part. It may comprise or be made from aluminum, which includes aluminum alloys.

The panel structure 10 comprises several first attachment component 14 configured for attaching the panel structure 10 to the front compartment structure 31 of the front compartment 30 as well as second attachment component 15 configured for attaching the climate control system 20 to the panel structure 10. The first and/or second attachment component 14, 15 may be designed as a through-hole, a threaded hole, a bushing, a screw and/or a bolt, for example.

Besides NVH reduction, the panel structure 10 provides for simpler, more ergonomic, and faster assembly of the front compartment 30 of vehicle 1, as illustrated by the method 100 of FIG. 5, showing the steps for such an improved assembly.

In a first step 102 of method 100, a climate control structure 50 is assembled by attaching the climate control system 20 to the panel structure 10 by the second attachment component 15. Any mechanism corresponding to the second attachment component 15, e.g., screws or bolts, may be used for this attachment. The first step 102 may therefore be carried out outside of the front compartment 30 or vehicle 1 and be a preassembly step. The preassembly has the advantage that a worker and/or robot has sufficient space for the assembly outside of the front compartment 30, casily reaching all the second attachment component 15 and establishing the attachment.

Then, in a second step 104 of method 100, the assembled climate control structure 50 is inserted into the front compartment 30 in the correct position and orientation to be attached to the front compartment structure 31.

Finally, in a third step 106 of method 100, the assembled climate control structure 50, specifically the panel structure 10 thereof, is attached via the first attachment component 14 to the front compartment structure 31.

Further, the panel structure 10 may ensure the supply of clean air from the climate control system 20 inside the front compartment 30 to the cabin compartment 40, in which the passengers of vehicle 1 are located. To achieve this, the panel structure 10 has a sealing component 17, which seals off a first compartment 32 as part of the front compartment 30, which may be configured to comprise the climate control system 20, in an air-flow restricting manner, in particular substantially air-tight, against a second compartment 33 of the front compartment 30, i.e., the front compartment 30 without the first compartment 32. Accordingly, by virtue of the panel structure 10, between the first compartment 32 and the second compartment 33, there may be substantially no or no significant air-leak between the panel structure 10 and the front compartment structure 31. Thereby, the climate control system 20 may for the most part or only use air via one or more air ducts 21 as intakes for the climate control system 20 rather than using air from inside the rest of the front compartment 30, which may be polluted or not desired as air for the cabin compartment 40.

As may be seen from FIG. 3, the sealing component 17 are designed as scaling strips, e.g., made from an elastomer, extending on the back face of the panel section 11 of the panel structure 10 between the two beam sections 12, 13. Further scaling component 17 may be provided on the beam sections 12, 13, or, the beam sections 12, 13 may be provided as scaling component 17 as such. When assembling the front compartment 30, the scaling component 17 are pressed and, optionally, adhered, against the front compartment structure 31, which may be from metal, for example, when attaching the panel structure 10 to the front compartment structure 31, thereby forming the air-flow restricting sealing between the first compartment 32 and the second compartment 33.

The panel structure 10 further comprises depressed portions 16 at its short sides and located on the panel section 11. These depressed portions 16 are depressed relative to the generally planar shape of the panel section 11. The depressed portions 16 conform in shape to the front compartment structure 31, in particular via surface contact, when attaching the panel structure 10 thereto.

Thereby, the sealing and attachment may be enhanced. For example, it is not necessary to use excessive amounts of sealing component 17 when the shapes of the panel structure 10 and the front compartment structure 31 correspond to each other to a high degree, which is herein enabled by the simple yet effective depressed portions 16. Another depression or bent at the panel section 11, in particular substantially extending along its entire length, may be seen best in FIG. 2, also provided for conforming to the shape of the front compartment structure 31.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including entities other than B); in another example, to at least one, optionally including more than one, B, with no A present (and optionally including entities other than A); in yet another example, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

Other variations to the disclosed examples can be understood and effected by those skilled in the art in practicing the claimed disclosure, from the study of the drawings, the disclosure, and the appended claims. In the claims the word “comprising” does not exclude other elements or steps and the indefinite article “a” or “an” does not exclude a plurality. Any reference signs in the claims should not be construed as limiting the scope of the claims.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein, two or more elements are “integral” if they comprise the same piece of material or if they operate functionally together. Two or more elements are “non-integral” if each comprises a different piece of material or if each element can operate functionally independently.

As used herein the term “component” refers to a distinct and identifiable part, element, subsystem, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software, and/or other engineering elements.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by machine-readable storage program instructions. These computer-readable program instructions can be provided to a processor of a general purpose computer, special purpose computer and/or other programmable data processing apparatus to produce a machine, such that the instructions, which execute via the processor of the computer or other programmable data processing apparatus, for implementing the functions/acts specified in the flowchart and/or block diagram block or blocks. These computer-readable program instructions can also be stored in a computer-readable storage medium that can direct a computer, a programmable data processing apparatus and/or other devices to function in a particular manner, such that the computer-readable storage medium having instructions stored therein can comprise an article of manufacture including instructions which can implement aspects of the function/act specified in the flowchart and/or block diagram block or blocks. The computer-readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

While this specification contains many specifics, these do not construc as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

### LIST OF REFERENCE SIGNS

1 vehicle
10 panel structure
11 panel section
12 first beam section
13 second beam section
14 first attachment component
15 second attachment component
16 depressed portion
17 sealing component
20 climate control system
21 air duct
30 front compartment
31 front compartment structure
32 first compartment
33 second compartment
40 cabin compartment
50 climate control structure
100 method
102 first step
104 second step
106 third step

What is claimed is:

1. A structure comprising:
a first attachment component configured for attaching the structure to a front compartment structure of a compartment of a vehicle such that the compartment is separated into a first compartment and a second compartment;
a second attachment component configured for attaching a climate control system to the structure such that the climate control system is located in the first compartment when the structure is attached to the front compartment structure; and
a sealing component configured for sealing off the first compartment of the compartment in an air-flow restricting manner against the second compartment when the structure is attached to the front compartment structure; and
wherein the structure is for noise, vibration, and harshness reduction inside the compartment.

2. The structure of claim 1, wherein the structure further comprising a panel section and at least one beam section extending along a side of the panel section.

3. The structure of claim 2, wherein the panel section is thinner than the at least one beam section in a direction of extension of the panel section that is perpendicular to the direction of extension of the at least one beam section along the side of the panel section.

4. The structure of claim 2, wherein the structure further comprising at least two beam sections.

5. The structure of claim 4, wherein the two beam sections extend along opposite sides of the panel section.

6. The structure of claim 2, wherein the first attachment component is arranged on the panel section and at least one of the at least one beam section.

7. The structure of claim 2, wherein the second attachment component is arranged on the panel section and at least one of the at least one beam section.

8. The structure of claim 2, wherein the sealing component is arranged at least at opposite sides of the panel section.

9. The structure of claim 1, wherein the sealing component is configured as at least one sealing strip.

10. The structure of claim 4, further comprising at least one depressed portion, the at least one depressed portion being depressed relative to a thereto adjacent portion of the structure and having a face configured for arrangement at a counter face of the front compartment structure.

11. The structure of claim 1, the structure being designed as an extrusion part and made from aluminum.

12. The structure of claim 1, further comprising: a climate control structure, wherein the climate control structure comprises the climate control system, and wherein the climate control system is attached to the structure.

13. The structure of claim 1, wherein a one of the first attachment component comprises at least one of a through-hole, a threaded hole, a bushing, a screw, and a bolt, and the second attachment component comprises one of a through-hole, a threaded hole, a bushing, a screw, and a bolt.

14. The structure of claim 5, wherein the opposite sides of the panel section are long sides of the panel section.

15. The structure of claim 8, wherein the sealing component is arranged on a flat surface of the panel section.

16. The structure of claim 10, wherein the depressed portion is arranged at the panel section.

17. The structure of claim 10, wherein the depressed portion is arranged between the two beam sections.

18. A compartment comprising:
a structure; and
a sealing component;
wherein the structure is attached to the compartment such that the compartment is separated into a first compartment and a second compartment;
wherein a climate control system is attached to the structure such that the climate control system is located in the first compartment when the structure is attached to the compartment; and
wherein the sealing component seals off the first compartment of the compartment in an air-flow restricting manner against the second compartment.

19. The compartment of claim 18, wherein the compartment is a front compartment structure of a vehicle.

20. A method comprising:
assembling a climate control structure by attaching a climate control system to a structure, wherein the climate control structure comprises the climate control system;
inserting the assembled climate control structure into a compartment; and
attaching the assembled climate control structure to a compartment structure of a vehicle, wherein the structure separates the compartment structure into a first compartment and a second compartment, and wherein the climate control system is located in the first compartment; and
sealing, the first compartment of the compartment in an air-flow restricting manner against the second compartment.
